(19) United States
(12) Patent Application Publication
(10) Pub. No.: US 2022/0222370 A1
(43) Pub. Date: Jul. 14, 2022

(54) PRIVACY CHANGE RISK REMEDIATION FOR DEPENDENT PRODUCT CODE

(71) Applicant: International Business Machines Corporation, Armonk, NY (US)

(72) Inventors: Paul R. Bastide, Ashland, MA (US); Xu Wang, Westford, MA (US); Rohit Ranchal, Austin, TX (US); Senthil Bakthavachalam, Yorktown Heights, NY (US); Shakil Manzoor Khan, Highland Mills, NY (US)

(21) Appl. No.: 17/146,837

(22) Filed: Jan. 12, 2021

(51) Int. Cl. G06F 21/62

(52) U.S. Cl. CPC G06F 21/6245

(57) ABSTRACT

Examples described herein provide a computer-implemented method that includes scanning, by a processing device, a code dependency list and a hierarchy of a core code component. The method further includes pulling, by the processing device, data of the core code using the scanned code dependency list. The method further includes extracting, by the processing device, information from the data for each dependency. The method further includes scoring, by the processing device, the information between versions to detect a likelihood of user data posture changes. The method further includes enforcing, by the processing device, a compensating control for the core code.

### BACKGROUND

Embodiments described herein generally relate to processing systems, and more specifically, to privacy change risk remediation for dependent product code.

In some processing system environments, sensitive data (e.g., medical data, financial data, legal data, etc.) from different sources co-exist. Such sensitive data can also co-exist with non-sensitive data. As an example, a processing system can utilize software from multiple vendors, can store data in databases offered by different vendors, etc. The data is ingested into the processing system, such as in a continuous fashion, using APIs and bulk loading. This generates an abundance of sensitive and non-sensitive data (e.g., gigabytes, terabytes, etc.). The software from different vendors may have certain dependencies to and among each other and/or to other proprietary software executing on the processing system. Further, different stakeholders (e.g., customers, users, administrators, etc.) can utilize the processing system to access portions of sensitive and non-sensitive data.

### SUMMARY

Embodiments of the present invention are directed to privacy change risk remediation for dependent product code.

A non-limiting example computer-implemented method includes scanning, by a processing device, a code dependency list and a hierarchy of a core code component. The method further includes pulling, by the processing device, data of the core code using the scanned code dependency list. The method further includes extracting, by the processing device, information from the data for each dependency. The method further includes scoring, by the processing device, the information between versions to detect a likelihood of user data posture changes. The method further includes enforcing, by the processing device, a compensating control for the core code.

According to one or more examples, the data of the core code includes core data, binary data, library data, source data, and documentation data.

According to one or more examples, the information includes interface parameters, user indicators, and output avenues.

According to one or more examples, the compensation control is at least one of a revert dependency action, a manage dependency action, an alert, and a block deployment action.

According to one or more examples, the scanning includes injecting a scan function into a processing pipeline of a project, wherein the scan function scans the dependency list and the hierarchy of the core code.

According to one or more examples, the pulling is performed using a central repository, or a set of product archive files, or deliverables.

According to one or more examples, the pulling is performed with respect to a prior bundled version, a current version, and an upversion.

According to one or more examples, the method further includes generating a change indicator between data of versions of a reference, the data of versions of the reference including: personally identifiable information type; personally identifiable information output location; path to output location; likelihood of storage output; and a change from a prior version.

Other embodiments of the present invention implement features of the above-described method in computer systems and computer program products.

Advantages of one or more embodiments described herein are to improve compliance with regulations, improve computer functionality by reducing data exposure risk by preventing upgrades to potentially-malicious versions and thereby preventing leaking of sensitive data, improve the traceability of core code with reference to patient/user data, and the like. Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a row in a dimensional model for a patient census fact table.

FIG. 2 depicts a block diagram of a processing system for managing privacy risk change according to one or more embodiments described herein

FIG. 3 depicts a flow diagram of a method for managing privacy risk change according to one or more embodiments described herein;

FIG. 4 depicts a dependency analysis according to one or more embodiments described herein;

FIG. 5 depicts a dependency tree according to one or more embodiments described herein;

FIG. 6 depicts results of a source code analysis according to one or more embodiments described herein;

FIG. 7 depicts a cloud computing environment according to one or more embodiments described herein;

FIG. 8 depicts abstraction model layers according to one or more embodiments described herein; and

FIG. 9 depicts a block diagram of a processing system for implementing the presently described techniques according to one or more embodiments described herein.

The diagrams depicted herein are illustrative. There can be many variations to the diagram or the operations described therein without departing from the scope of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments of the present invention provide for privacy change risk remediation for dependent product code. On some processing systems, sensitive and non-sensitive data co-exists. Sensitive data includes any data that causes a person associated with the data to be identifiable. Sensitive data can include, for example, medical data, financial data, legal data, etc. Software and/or libraries, from different vendors, executing on the processing system may have certain dependencies to and among each other and/or to other proprietary software executing on the processing system. For example, IBM® provides a platform that is a multi-tenant healthcare solution where electronic health records (EHR), protected healthcare information (PHI), personally identifiable information (PII), and medical event data co-exist. Such data is provided by multiple vendors, customers, and organizations, such as on a single logical data processing system. The data is ingested into the platform in a continuous fashion using APIs and bulk loading, which generates an abundance of sensitive and non-sensitive data (e.g., gigabytes, terabytes, etc.) that co-exist on the platform.

Jurisdictions have certain data protection and privacy laws and regulations to protect sensitive data, such as certain sensitive medical data (e.g., EHR and PHI data). Examples of such laws and regulations include the General Data Protection Regulation (GDPR), the Health Insurance Portability and Accountability Act of 1996 (HIPAA), and others.

When a vendor updates its software, it can inadvertently cause sensitive data to be made available when or where it should not be available. For example, proprietary software executes on a processing system and uses a third-party vendor library. If the library is updated by the third-party vendor (e.g., to support new functionality), it may unintentionally cause the unexpected flow of sensitive data into a new location, log, or output, which risks sensitive data exposure. Such an unexpected flow of sensitive data may end up on unencrypted disks, available via unsecured ports, aggregated in a log analysis tool, or ingested into another unintended resource or location. The seemingly innocent data risk is always there in third-party software, thus risking unintentional exposure of sensitive data, such as patient data or PII.

An example of such an unexpected flow of sensitive data is now described. Consider the following code having data elements:

```
{
  “resourceType”: “Patient”,
  “id”: “pat1”,
  “name”: [
  {
    “use”: “official”,
    “family”: “Donald”,
    “given”: [
        “Duck”
      ]
    }
  ]
}
```

Elements of the data elements in this code contain identified patient references (e.g., “name,” “family,” “given,” etc.). These references may end up being exposed unintentionally.

As another example, consider the following information contained in a log file:

zone borough patient
Newark Airport EWR Fred
Jamaica Bay Queens Jason

Again, these references to sensitive data may end up being exposed unintentionally.

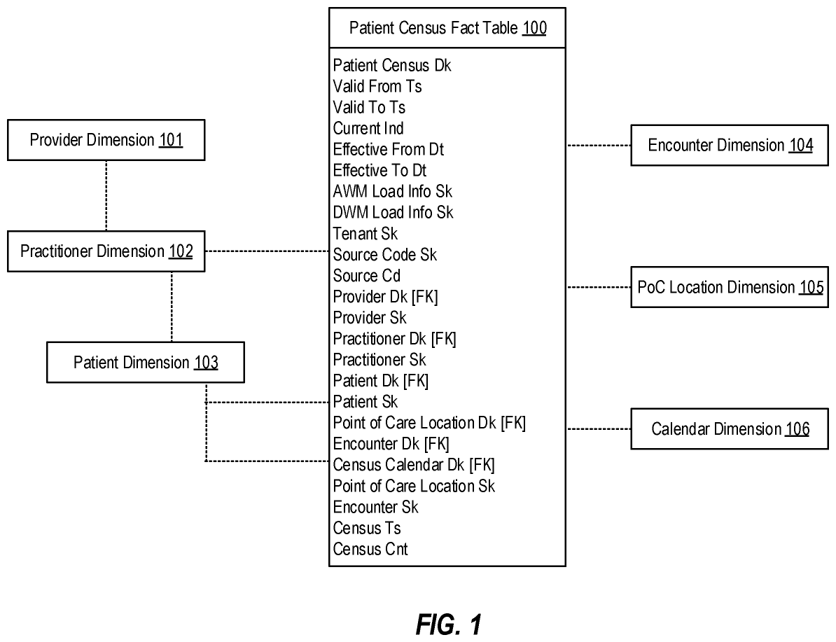

Yet another example is shown in FIG. 1, which depicts a row in a dimensional model for a patient census fact table 100. The patient census fact table 100 includes several dimension tables, including: provider dimension 101, practitioner dimension 102, patient dimension 103, encounter dimension 104, point of care location dimension 105, and calendar dimension 106. Each of the dimensions 101-106 represents potential points of risk for sensitive data exposure when an update to third-party software/libraries occurs that uses these dimensions 101-106.

Conventional techniques for mitigating these risks rely on runtime and dependency graph management which includes only certain versions that should be used and promoted. However, this approach in itself is risky in privacy and regulated environments as the signature changes, because there is an inherited risk that should be carefully managed in a regulated environment, such as healthcare.

The above-described aspects of the invention address the shortcomings of the prior art by limiting exposure of sensitive data by third-party vendors as their respective libraries or software are upgraded. Particularly, described herein are embodiments that manage privacy risk change. One embodiment for managing privacy risk change is as follows. A dependency list and hierarchy of the core code are scanned. The core, binary, library, source, documentation, etc. related to the dependency in the list are then pulled. Interface parameters, user/patient indicators, and output avenues (net, log, db) are then extracted from each dependency's pulled data. The extracted information is scored between versions to detect the likelihood of sensitive data posture changes. Compensating controls are then enforced for the core code, such as a revert dependency action, a manage dependency action, an alert, a block deployment action, etc.

One or more embodiments of the present invention provide technical solutions to one or more of the disadvantages of existing solutions by providing an improved approach to manage privacy risk change and thus limiting exposure of sensitive data by third-party vendors as their respective libraries or software are upgraded. These techniques improve compliance with regulations, improve computer functionality by reducing data exposure risk by preventing upgrades to potentially-malicious versions, and the like. Further, the present techniques improve the traceability of core code with reference to patient/user data. It should be appreciated that the presently described examples of technical features, technical effects, and improvements to technology of example embodiments of the disclosure are merely illustrative and not exhaustive.

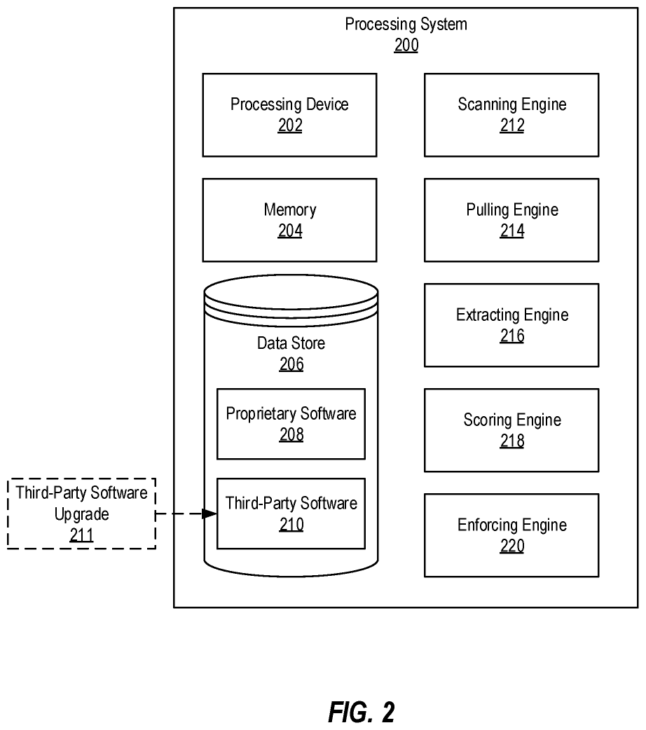

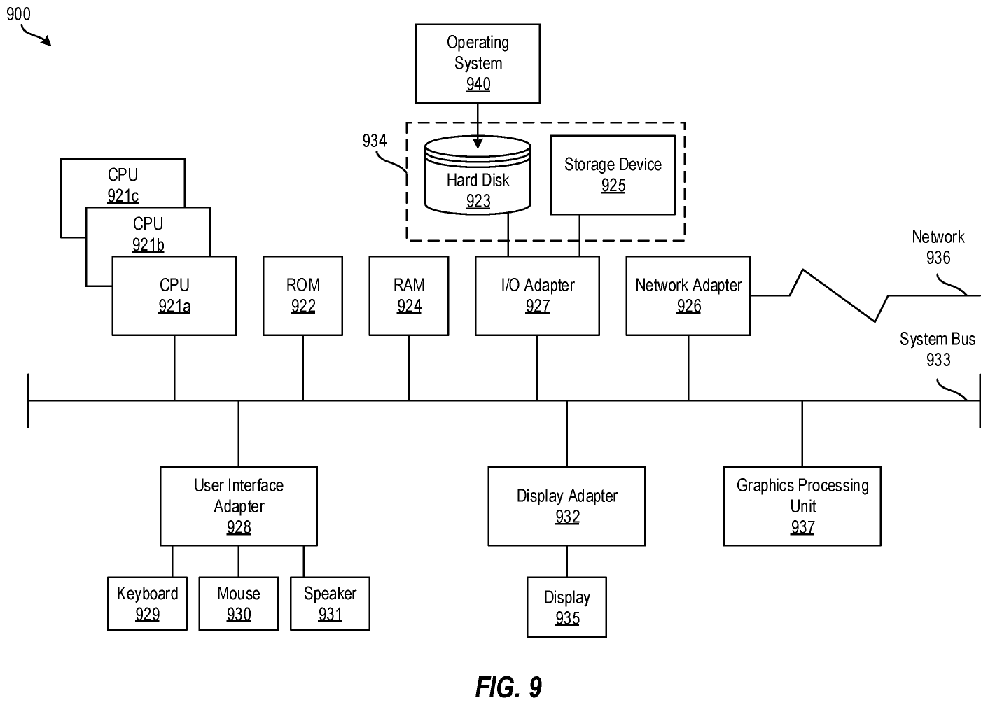

Turning now to FIG. 2, a system diagram of a processing system 200 for managing privacy risk change is depicted according to one or more embodiments described herein. The processing system 200 includes a processing device 202 (e.g., one or more of the processors 921 of FIG. 9), a memory 204 (e.g., the RAM 924 of FIG. 9), and a data store 206 (e.g., the mass storage 934 of FIG. 9). The data store 206 stores proprietary software 208 and third-party software 210, which can be a stand-alone application and/or library. When a third-party software upgrade 211 is available, the processing system 200 determines whether the third-party software upgrade 211 is more likely than the third-party software 210 to cause sensitive data to be exposed. Particularly, the processing system 200 looks at dependent code of the third-party software 210 and the third-party software upgrade 211 to identify changes in behavior between the third-party software 210 and the third-party software upgrade 211. The behavior is used to determine whether the probability of sensitive data being exposed is more likely with the third-party software upgrade 211 than the third-party software 210.

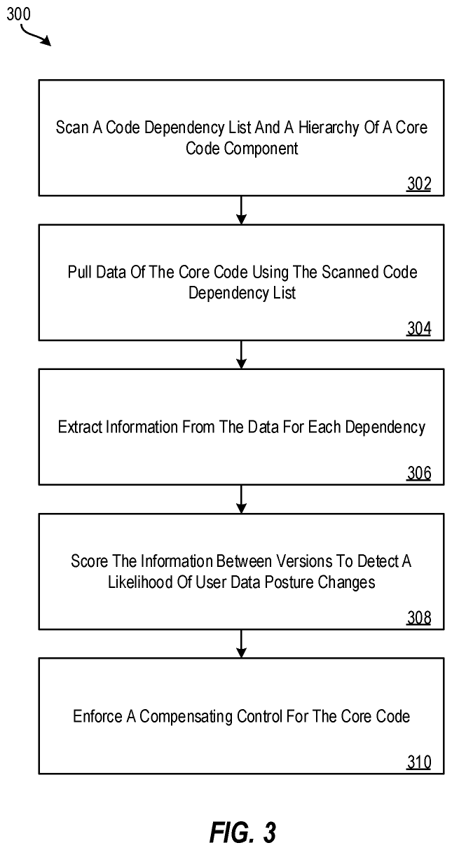

To accomplish this, the processing device 300 utilizes a plurality of engines as follows: a scanning engine 212, a pulling engine 214, an extracting engine 216, a scoring engine 218, and an enforcing engine 220. These engines enable the processing system 200 to scan a dependency list, pull core components, extract information from the core components, determine an output, perform scoring between different versions of the third-party software 210 to detect potential data leaks (such as buffer overflows, outdated code, etc.) and then enforce controls on how or whether to install the third-party software upgrade 211. This provides the technical improvement of guarding against accidental leaking of sensitive data, such as PII data. The features and functionality of these engines are described in more detail in FIG. 3.

The various components, modules, engines, etc. described regarding FIG. 2 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 202 for executing those instructions. Thus a system memory (e.g., the memory 204) can store program instructions that when executed by the processing device 202 implement the engines described herein. Other engines can also be utilized to include other features and functionality described in other examples herein.

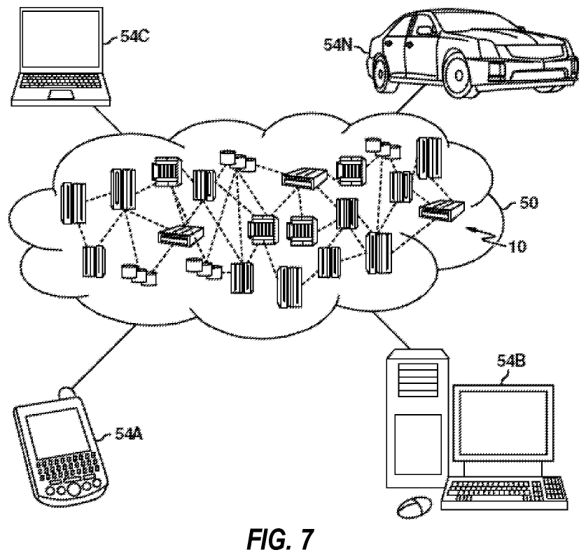

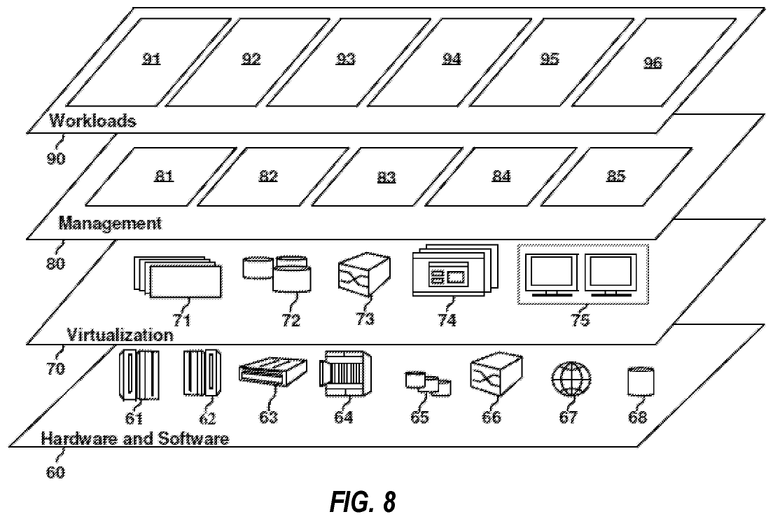

Turning now to FIG. 3, a flow diagram of a method 300 for managing privacy risk change is depicted according to one or more embodiments described herein. The method 300 can be implemented using any suitable processing system (e.g., the processing system 200, the processing system 900 of FIG. 9, any suitable processing device (e.g., the processing device 202, the processors 921 of FIG. 9), combinations thereof, and the like. In some examples, the method 300 can be implemented in a cloud computing environment (see, e.g., FIGS. 8 and 7). The method 300 is now described with reference to the engines 212, 214, 216, 218, 220 of FIG. 2 but is not so limited.

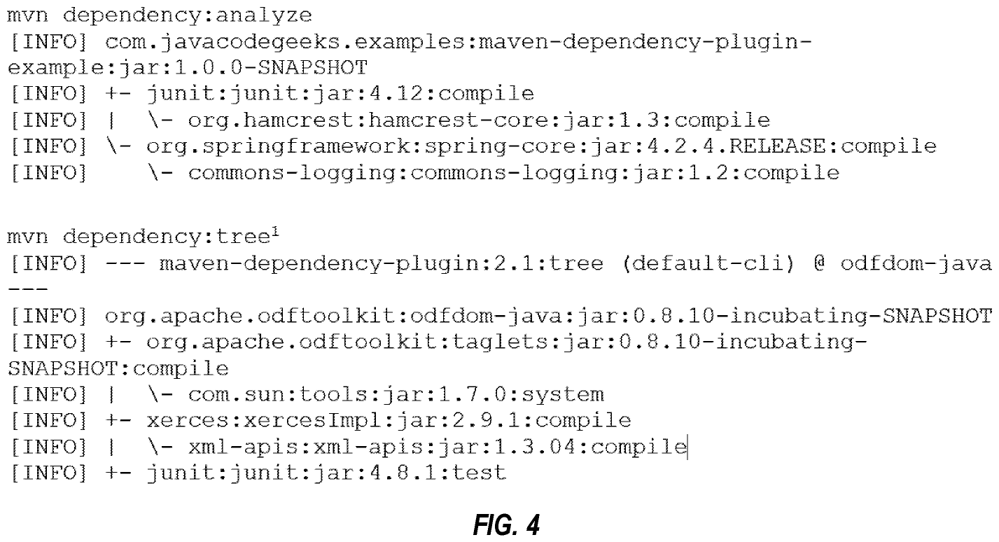

At block 302, the scanning engine 212 scans a code dependency list and a hierarchy of a core code component. According to one or more embodiments described herein, the scanning engine 212 injects a scan function into a processing pipeline (e.g., a continuous integration (CI)/continuous delivery (CD) pipeline) of a project. In such cases, when the scanning engine 212 scans, the scan function scans the dependency list and the hierarchy of the core code. The scanning engine 212 injects into a CI/CD pipeline a scan of the dependency list and the hierarchy of the code, as shown in FIG. 4.

In examples, the code dependency list can be determined using Grafeas or JFrog X-Ray or Maven dependencies. The scanning engine 212 scans the code of the third-party software 210 and/or the third-party software upgrade 211 using static analysis techniques to parse the code into an inter-related series. In examples, a recording function (i.e., a scan function) is then injected, which stores the parameters and the descriptions for the parameters (if comments are embedded or included in the relevant documentation).

With continued reference to FIG. 3, at block 304, the pulling engine 214 pulls data of the core code using the scanned code dependency list. According to one or more embodiments described herein, the data of the core code can include core data, binary data, library data, source data, documentation data, and/or other suitable types of data. In examples, the pulling is performed using a central repository, a set of product archive files related to the third-party software 210, and/or deliverables relating to the third-party software upgrade 211. According to one or more embodiments described herein, the pulling is performed with respect to a prior bundled version (e.g., a prior version of the third-party software 210), a current version (e.g., the third-party software 210), and an upversion (e.g., the third-party software upgrade 211).

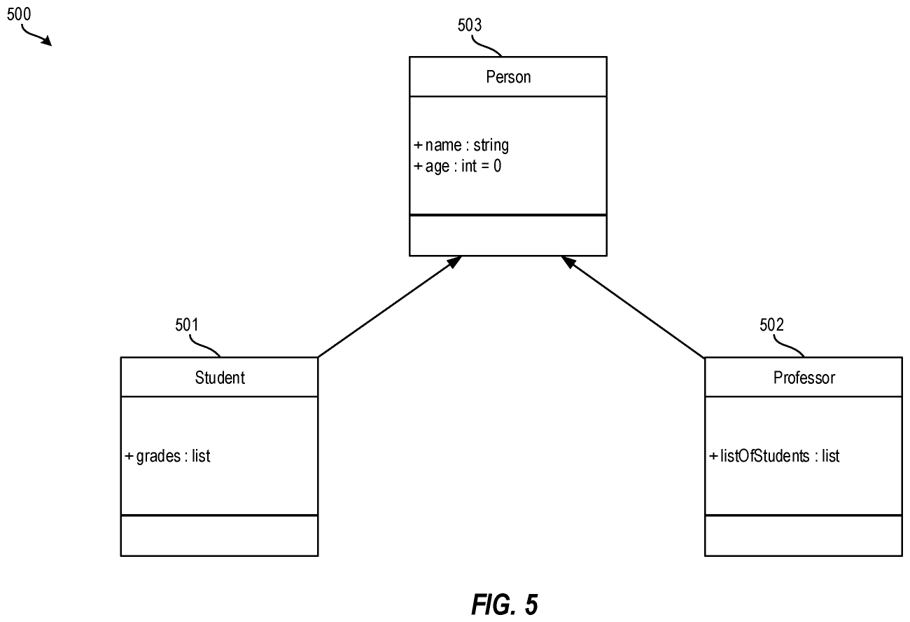

It examples, the pulling engine 214 can utilize an analysis tool to eliminate NullPointerExcepctions (NPEs) in code, which can be extended using a parser library that allows parsing and formatting of source code files. Dependencies are identified, such as shown in the dependency tree 500 of FIG. 5. In particular, the dependency tree 500 shows dependencies from a student table 501 and a professor table 502 to a person table 503. For each of these dependencies and source code elements shown in FIG. 5, the pulling engine 214 pulls one or more of data, binary data, library data, source data, and documentation data related to the dependency in the list to the processing system 200. This can be accomplished, for example, using a centralized repository (e.g., Jfrog Artifactory, Maven Central, Sonatype Nexus). In some examples, the pulling engine 214 picks the dependencies from a product zip file or deliverables or another repository.

The puling engine 214 identifies a hierarchical tree (see, e.g., the dependency tree 500 of FIG. 5) and call traces in the source code, and from the tree, it can be determined that the calls are logging calls that are leaking sensitive information. The processing system 200 then traces back and highlights in the depths that the code is exposing in unintended ways. In some examples, the pulling engine 214 can pick a prior version of the of the third-party software 210, the current version the third-party software 210, and the third-party software upgrade (upversion) 211 from the current dependency.

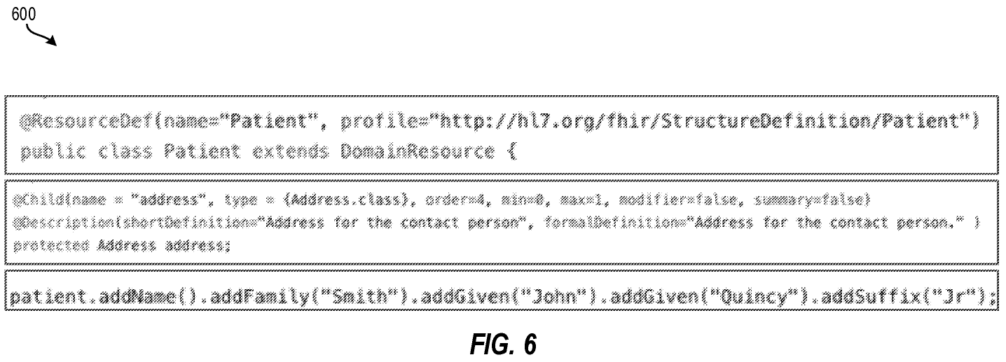

With continued reference to FIG. 3, at block 306, the extracting engine 216 extracts information from the data for each dependency. According to one or more embodiments described herein, the information can include interface parameters, user indicators, output avenues, and/or other suitable information. For example, the extracting engine 216 extracts the interface parameters, user/patient indicators and output avenues (net, log, db) from each dependency's pulled data. To do this, the extracting engine 216 scans the code by performing a source code analysis to identify references to user or patient identifiers commonly found in PII. An example of results 600 from such an analysis are shown in FIG. 6 according to one or more embodiments described herein. The extracting engine 216 then identifies calls found in static references to logging facilities and likely log levels. The extracting engine 216 next identifies stack calls to mutated or changed logging facilities. For example, the extracting engine 216 identifies an increase in logging in the third-party software upgrade 211 compared to logging in the third-party software 210. Finally, the extracting engine 216 scans through the source code or reflection data for the third-party software upgrade 211 to identify references. For each reference, the extraction engine 216 generates a change between the versions (e.g., between the third-party software 210 and the third-party software upgrade 211), using a total path change or destination change. The extracting engine 216 uses destinations of network, disk, memory or datastore, such as: PII type (e.g., a username, a password, an address, etc.); PII output location (e.g., disk, database, etc.); a path to output location; a likelihood of storage/output; and/or a change from prior version.

With continued reference to FIG. 3, at block 308, the scoring engine 218 scores the information between versions to detect a likelihood of user data posture changes. For example, the scoring engine 218 calculates a score as follows: change from prior version*likelihood*PII type (score per type)*output type. For instance, the change from prior version is 2 of 10, likelihood is 1 of 5, type is 10 yields a score of 20. The scoring engine 218 can also evaluate trends (up vs. down) in scores between versions over time. An upward trend may indicate an increased probability of leakage of sensitive data over time (across multiple version changes), while a downward trend may indicate a decreased probability of leakage of sensitive data over time.

At block 310, the enforcing engine 220 enforces a compensating control for the core code. The compensating control is an action that can aid in preventing unintentional leaking of sensitive data, such as PII data, and therefore represents an improvement to computing technology, namely preserving data privacy. Continuing with the scoring example from block 308, the enforcing engine 220 sees that the score is 20 and implements a first level of compensating controls, such as reverting a dependency to a known state. The enforcing engine 220 can take different actions depending on the score and/or change to score over time. For example, according to one or more embodiments described herein, the compensation control can include of a revert dependency action, a manage dependency action, an alert, a block deployment action, and/or other suitable actions. The revert dependency action reverts a dependency to a known state. The manage dependency action manages how the proprietary software 208 interacts with the third-party software 210. The alert action provides an alert, such as to an administrator, of a potential for leaking of sensitive data. The block deployment action prevents the third-party software upgrade 211 from being installed on the processing system 200. In some examples, the enforcing engine 220 can identify and validate any given risk and change by running the code through tools such as Mockito, EasyMock, JMockit to determine the degree of leakage, also known as out flow. In examples, the enforcing engine 220 also injects custom loggers into a unit test framework to replace the used logger and turn on worst case logging.

Additional processes also may be included. For example, the method 300 can include generating a change indicator between data of versions of a reference. The data includes one or more of the following: personally identifiable information type (e.g., a username, a password, a name, an address); personally identifiable information output location; path to output location; likelihood of storage output; and a change from a prior version. It should be understood that the process depicted in FIG. 3 represents an illustration, and that other processes may be added or existing processes may be removed, modified, or rearranged without departing from the scope of the present disclosure.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and privacy change risk remediation for dependent product code 96.

It is understood that one or more embodiments described herein is capable of being implemented in conjunction with any other type of computing environment now known or later developed. For example, FIG. 9 depicts a block diagram of a processing system 900 for implementing the techniques described herein. In accordance with one or more embodiments described herein, the processing system 900 is an example of a cloud computing node 10 of FIG. 7. In examples, processing system 900 has one or more central processing units (“processors” or “processing resources”) 921a, 921b, 921c, etc. (collectively or generically referred to as processor(s) 921 and/or as processing device(s)). In aspects of the present disclosure, each processor 921 can include a reduced instruction set computer (RISC) microprocessor. Processors 921 are coupled to system memory (e.g., random access memory (RAM) 924) and various other components via a system bus 933. Read only memory (ROM) 922 is coupled to system bus 933 and may include a basic input/output system (BIOS), which controls certain basic functions of processing system 900.

Further depicted are an input/output (I/O) adapter 927 and a network adapter 926 coupled to system bus 933. I/O adapter 927 may be a small computer system interface (SCSI) adapter that communicates with a hard disk 923 and/or a storage device 925 or any other similar component. I/O adapter 927, hard disk 923, and storage device 925 are collectively referred to herein as mass storage 934. Operating system 940 for execution on processing system 900 may be stored in mass storage 934. The network adapter 926 interconnects system bus 933 with an outside network 936 enabling processing system 900 to communicate with other such systems.

A display (e.g., a display monitor) 935 is connected to system bus 933 by display adapter 932, which may include a graphics adapter to improve the performance of graphics intensive applications and a video controller. In one aspect of the present disclosure, adapters 926, 927, and/or 932 may be connected to one or more I/O busses that are connected to system bus 933 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 933 via user interface adapter 928 and display adapter 932. A keyboard 929, mouse 930, and speaker 931 may be interconnected to system bus 933 via user interface adapter 928, which may include, for example, a Super I/O chip integrating multiple device adapters into a single integrated circuit.

In some aspects of the present disclosure, processing system 900 includes a graphics processing unit 937. Graphics processing unit 937 is a specialized electronic circuit designed to manipulate and alter memory to accelerate the creation of images in a frame buffer intended for output to a display. In general, graphics processing unit 937 is very efficient at manipulating computer graphics and image processing, and has a highly parallel structure that makes it more effective than general-purpose CPUs for algorithms where processing of large blocks of data is done in parallel.

Thus, as configured herein, processing system 900 includes processing capability in the form of processors 921, storage capability including system memory (e.g., RAM 924), and mass storage 934, input means such as keyboard 929 and mouse 930, and output capability including speaker 931 and display 935. In some aspects of the present disclosure, a portion of system memory (e.g., RAM 924) and mass storage 934 collectively store the operating system 940 such as the AIX® operating system from IBM Corporation to coordinate the functions of the various components shown in processing system 900.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for privacy change risk remediation for dependent product code, the method comprising:
scanning, by a processing device, a code dependency list and a hierarchy of a core code component;
pulling, by the processing device, data of the core code using the scanned code dependency list;
extracting, by the processing device, information from the data for each dependency;
scoring, by the processing device, the information between versions to detect a likelihood of user data posture changes; and
enforcing, by the processing device, a compensating control for the core code.

2. The computer-implemented method of claim 1, wherein the data of the core code comprises core data, binary data, library data, source data, and documentation data.

3. The computer-implemented method of claim 1, wherein the information comprises interface parameters, user indicators, and output avenues.

4. The computer-implemented method of claim 1, wherein the compensation control is at least one of a revert dependency action, a manage dependency action, an alert, and a block deployment action.

5. The computer-implemented method of claim 1, wherein the scanning comprises injecting a scan function into a processing pipeline of a project, wherein the scan function scans the dependency list and the hierarchy of the core code.

6. The computer-implemented method of claim 1, wherein the pulling is performed using a central repository, or a set of product archive files, or deliverables.

7. The computer-implemented method of claim 1, wherein the pulling is performed with respect to a prior bundled version, a current version, and an upversion.

8. The computer-implemented method of claim 1 further comprising:
generating a change indicator between data of versions of a reference, the data of versions of the reference comprising:
personally identifiable information type;
personally identifiable information output location;
path to output location;
likelihood of storage output; and
a change from a prior version.

9. A system comprising:
a memory comprising computer readable instructions; and
a processing device for executing the computer readable instructions, the computer readable instructions controlling the processing device to perform operations for privacy change risk remediation for dependent product code, the operations comprising:
scanning a code dependency list and a hierarchy of a core code component;
pulling data of the core code using the scanned code dependency list;
extracting information from the data for each dependency;
scoring the information between versions to detect a likelihood of user data posture changes; and
enforcing a compensating control for the core code.

10. The system of claim 9, wherein the data of the core code comprises core data, binary data, library data, source data, and documentation data.

11. The system of claim 9, wherein the information comprises interface parameters, user indicators, and output avenues.

12. The system of claim 9, wherein the compensation control is at least one of a revert dependency action, a manage dependency action, an alert, and a block deployment action.

13. The system of claim 9, wherein the scanning comprises injecting a scan function into a processing pipeline of a project, wherein the scan function scans the dependency list and the hierarchy of the core code.

14. The system of claim 9, wherein the pulling is performed using a central repository, or a set of product archive files, or deliverables.

15. The system of claim 9, wherein the pulling is performed with respect to a prior bundled version, a current version, and an upversion.

16. The system of claim 9, wherein the operations further comprise:
generating a change indicator between data of versions of a reference, the data of versions of the reference comprising:
personally identifiable information type;
personally identifiable information output location;
path to output location;
likelihood of storage output; and
a change from a prior version.

17. A computer program product comprising a computer readable storage medium having program instructions embodied therewith, the program instructions executable by a processor to cause the processor to perform operations for privacy change risk remediation for dependent product code, the operations comprising:
scanning a code dependency list and a hierarchy of a core code component;
pulling data of the core code using the scanned code dependency list;
extracting information from the data for each dependency;
scoring the information between versions to detect a likelihood of user data posture changes; and
enforcing a compensating control for the core code.

18. The computer program product of claim 17, wherein the data of the core code comprises core data, binary data, library data, source data, and documentation data.

19. The computer program product of claim 17, wherein the information comprises interface parameters, user indicators, and output avenues.

20. The computer program product of claim 17, wherein the compensation control is at least one of a revert dependency action, a manage dependency action, an alert, and a block deployment action.
